(19) United States
(12) Patent Application Publication
(10) Pub. No.: US 2002/0118098 A1
(43) Pub. Date: Aug. 29, 2002

(54) System for a machine or plant having a large number of sensors and/or actuators

(76) Inventor: Christoffer Apneseth, Oslo (NO)

Correspondence Address: LERNER AND GREENBERG, P.A., Post Office Box 2480, Hollywood, FL, 33022-2480, US

(21) Appl. No.: 10/080,361

(22) Filed: Feb. 21, 2002

(30) Foreign Application Priority Data
Feb. 21, 2001 (DE) 101 08 243.6

(51) Int. Cl. H04Q 5/22

(52) U.S. Cl. 340/10.34; 340/572.7

(57) ABSTRACT

A system is proposed for a machine or plant having a large number of sensors and/or actuators. At least one communications device is provided, to which at least two sensors and/or actuators are connected via short connecting cables, is mounted on the machine or plant. The communications device has a modulator/coder with a downstream radio transmitter for transmitting sensor signals, and/or has a radio receiver with a downstream demodulator/decoder for receiving actuator drive signals. The communications device communicates via radio signals with a base station, which is connected to a central computer for the machine or plant. The base station has a radio receiver with a downstream demodulator/decoder for receiving sensor signals, and/or has a modulator/coder with a downstream radio transmitter for transmitting actuator drive signals.

### BACKGROUND OF THE INVENTION

### FIELD OF THE INVENTION

The invention relates to a system for a machine or plant having a large number of sensors and/or actuators.

A system for a machine having a large number of proximity sensors, in particular an automated machine tool, is known from Published, Non-Prosecuted German Patent Application DE 199 26 799 A1. In the system, each proximity sensor has at least one secondary winding that is suitable for absorbing energy from a medium-frequency magnetic field. At least one primary winding, which is supplied from a medium-frequency oscillator, is intended for supplying electrical power to the proximity sensors without the use of a wire. Each proximity sensor is equipped with a transmitting device, which emits radio signals, containing sensor information of interest, to a central receiving device that is connected to a process computer for a machine.

A system for a machine having a large number of actuators, in particular an automated machine tool, is known from German Patent Application DE 199 26 562. Each of the actuators has at least one secondary winding which is suitable for absorbing energy from a medium-frequency magnetic field. In which at least one primary winding, which is supplied from a medium-frequency oscillator, is intended for supplying electrical power to actuators without the use of wires, and in which each actuator is equipped with a receiving device, which receives radio signals from a central transmitting device which is connected to a process computer for the machine.

These known systems have the advantage that, in comparison to conventional solutions with a cable connection for communication and for supplying electrical power to the sensors/actuators, they avoid the relatively high cost factor for a cable connection, resulting from the engineering, plant material, installation, documentation and maintenance. No failures can occur as a result of cable fractures or poor, for example corroded, contents.

### SUMMARY OF THE INVENTION

It is accordingly an object of the invention to provide a system for a machine or plant having a large number of sensors and/or actuators which overcomes the above-mentioned disadvantages of the prior art devices of this general type, which system is optimized for specific types of machines or plant, in particular robots, in which the sensors and/or actuators occur in large numbers and relatively close together at specific locations.

With the foregoing and other objects in view there is provided, in accordance with the invention, a system for a machine or plant having a large number of units being sensors and/or actuators. The system contains connecting cables, and at least one communications device connected to at least two of the units through the connecting cables. The communication device is mounted on the machine or the plant. The communications device has a modulator/coder and a radio transmitter for transmitting sensor signals disposed downstream of the modulator/coder, and/or a radio receiver and a demodulator/decoder for receiving actuator drive signals disposed downstream of the demodulator/decoder. A base station communicates via radio signals with the communications device. The base station has a radio receiver and a demodulator/decoder for receiving sensor signals disposed downstream of the radio receiver, and/or a modulator/coder with a radio transmitter for transmitting actuator drive signals disposed downstream of the radio transmitter. A central computer is connected to the base station.

The advantages which can be achieved by the invention are, in particular, that the proposed system is, for example, more cost-effective for robot arms with sensors and/or actuators which occur in large numbers at specific locations and, furthermore, is lighter in weight that the solutions proposed in the documents Published, Non-Prosecuted German Patent Applications DE 199 26 799 A1 and German Patent Application DE 199 26 562, in which a dedicated communications device is provided in each individual sensor and/or each individual actuator. The proposed system is, of course, also more cost-effective and its weight is less in comparison to a conventional system with sensors and/or actuators connected by wires. The proposed system leads to robot arms whose weights are advantageously reduced, and this has an advantageous effect in terms of the dynamics of the arms and the drive power levels required to move the robot arms.

Since the connecting lines between the sensors and/or actuators and the common communications device are very short and are never routed via moving joints between robot sections, the wear on the connecting lines is also only very low. In complete contrast to a robot arm with conventionally wired sensors and/or actuators, in which the connecting lines must be configured to be sufficiently flexible that they allow all the movements between the various robot sections. This accordingly results in fatigue (wear) to the connecting lines throughout the life of the robot arm, and there is a risk of fatigue fractures. This risk is completely avoided by the proposal according to the invention.

In accordance with an added feature of the invention, the communications device also supplies electrical power to the units. A magnetic field production apparatus is provided and is connected to at least one primary winding and the primary winding produces a magnetic field. The primary winding is disposed in an area of the machine or plant such that the machine or plant is located in an area of influence of the primary winding. The communications device has at least one secondary winding suitable for absorbing energy from the magnetic field, and a rectifier is disposed downstream of the secondary winding.

In accordance with another feature of the invention, at least one resonant capacitor is disposed in series or parallel with the primary winding and/or the secondary winding to form resonant circuits.

Other features which are considered as characteristic for the invention are set forth in the appended claims.

Although the invention is illustrated and described herein as embodied in a system for a machine or plant having a large number of sensors and/or actuators, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, illustration of a configuration with a robot arm and a large number of sensors/actuators in accordance with the invention;

FIG. 2 is a circuit diagram of a layout of the sensors/actuators and a common communications device; and

FIG. 3 is a circuit diagram of a layout of a base station.

### DESCRIPTION OF THE PREFERRED EMBODIMENTS

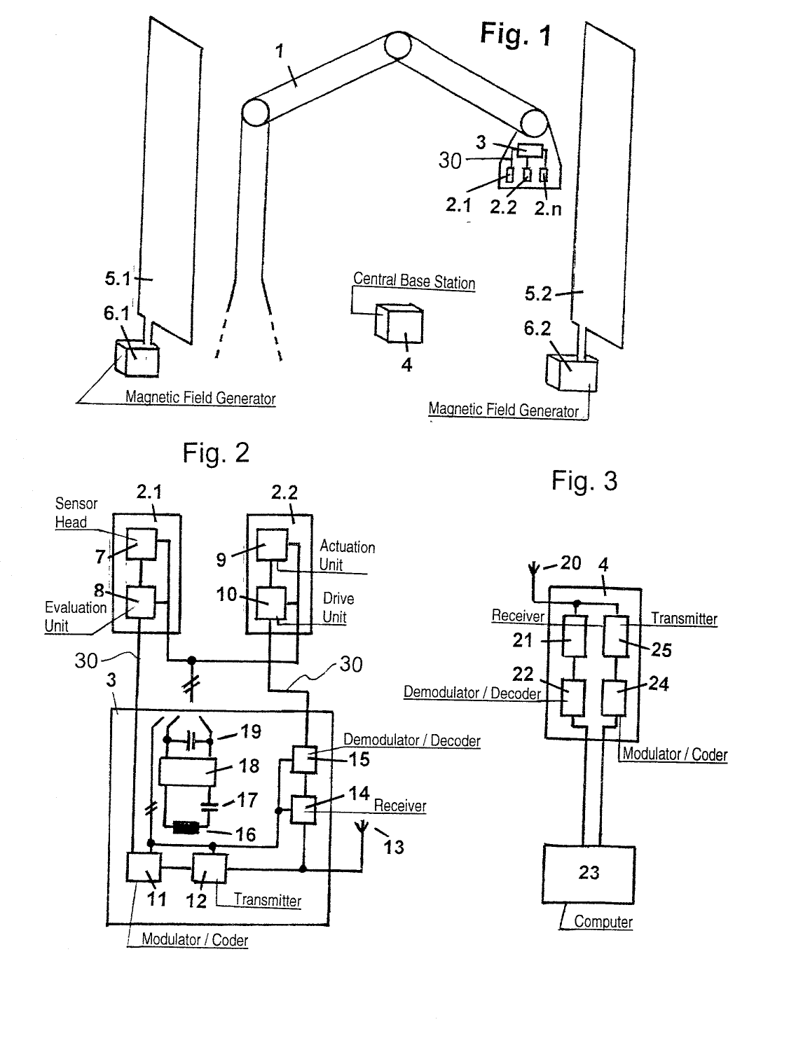

Referring now to the figures of the drawing in detail and first, particularly, to FIG. 1 thereof, there is shown a configuration with a robot arm 1 and a large number of sensors and/or actuators 2.1, 2.2 . . . 2.n. The robot arm 1 can bend at a number of joints, and has a group of relatively closely adjacent sensors/actuators 2.1, 2.2 . . . 2.n installed on an end joint section of the robot arm 1. The following text always refers to sensors/actuators although, possibly, this may also relate to sensors or actuators. The sensors/actuators 2.1, 2.2 . . . 2.n are connected via short connecting cables 30 to a common communications device 3, which is likewise installed on an end joint section of the robot arm 1.

The communications device 3 contains necessary radio transmitters and/or radio receivers in order to provide such wire-free communication with a central base station 4. Details relating to this are described in FIGS. 2 and 3

The electrical power supply to the sensors/actuators 2.1 . . . 2.n preferably likewise makes use of the common communications device 3. In order to supply electricity without the use of wires, two primary windings 5.1 and 5.2 are installed on both sides of the robot arm 1, each is connected to a magnetic field production apparatus 6.1 or 6.2, respectively. The magnetic field production apparatuses 6.1, 6.2 have an oscillator, which supplies the primary windings 5.1, 5.2 with a medium-frequency oscillation in the band from about 15 kHz to about 15 MHz, and with the primary windings preferably being connected in parallel or in series with a resonant capacitor. A medium-frequency magnetic field is formed, in particular, between the primary windings 5.1, 5.2. The communications device 3 contains at least one secondary winding. The purely magnetic coupling between the primary winding 5.1, 5.2 and the secondary winding, in the sense of a medium-frequency transformer, results in the secondary winding converting magnetic power to electrical power.

Other configurations may, of course, also be used for producing magnetic fields, for example three primary windings disposed at right angles to one another.

In the embodiment shown in FIG. 1, there is only a single group of sensors/actuators, and these are connected via the short wire connections (connecting lines) 30 to the common communications device 3. This should be regarded as being only by way of example since, of course, further groups of sensors/actuators may be located on the other joint sections of the robot arm 1, and these are likewise each connected to their own communications device.

FIG. 2 shows a layout of the sensors/actuators 2.1, 2.2 . . . 2.n, the common communications device 3 and FIG. 3 shows the base station 4 in detail. FIG. 2 shows the communications device 3, with the sensor 2.1 and the actuator 2.2 connected to it. The connections are in each case made via the short connecting lines 30. Further sensors and/or actuators may, of course, be connected to the common communications device 3. The sensor 2.1 has a sensor head 7, which detects the sensor environment and has a downstream signal evaluation unit 8. The preprocessed sensor signal is passed to a modulator/coder 11 with a downstream radio transmitter 12 and antenna 13.

The actuator 2.2 has an actuator unit 9, for example a compressed air valve or a contactor, as well as a drive unit 10 for it. The drive unit 10 is connected to a demodulator/decoder 15 for the communications device 3. A radio receiver 14 is connected upstream of the demodulator/decoder 15, and is connected to the antenna 13.

As has already been mentioned above, the communications device 3 expediently has an electrical power supply unit, which is used for supplying the components of the connected sensors and/or actuators 2.1, 2.2 . . . 2.n and for supplying the components of the communications device 3 itself. The power supply unit contains at least one secondary winding 16, a resonant capacitor 17 disposed in parallel or in series, a rectifier 18 and an energy store 19 at a DC output of the rectifier 18. A voltage which can be tapped off from the rectifier 18 is supplied to the sensor head 7, to the signal evaluation unit 8, possibly to the actuator unit 9, to the drive unit 10, as well as to the modulator/coder 11, to the radio transmitter 12, to the radio receiver 14 and to the demodulator/decoder 15. Actuator units that—apart from the drive—are not operated electrically but, for example, by compressed air, can, of course, also be used.

Other secondary winding configurations can, of course, also be used, for example three secondary windings disposed at right angles to one another.

FIG. 3 shows the base station 4, which is connected to a central computer 23 (processor computer, programmable logic controller), has an antenna 20 to which a radio receiver 21 and a radio transmitter 25 are connected. The signals from the radio receiver 21 are supplied to a demodulator/decoder 22, which is connected to the central computer 23. A modulator/coder 24 is connected upstream of the radio transmitter 25, and is likewise connected to the central computer 23.

I claim:

1. A system for a machine having a large number of units selected from the group consisting of sensors and actuators, the system comprising:
connecting cables;
at least one communications device connected to at least two of the units through said connecting cables, said communication device mounted on the machine, said communications device having at least one of a modulator/coder and a radio transmitter for transmitting sensor signals disposed downstream of said modulator/coder, and a radio receiver and a demodulator/decoder for receiving actuator drive signals disposed downstream of said demodulator/decoder;
a base station communicating via radio signals with said communications device, said base station having at least one of a radio receiver and a demodulator/decoder for receiving sensor signals disposed downstream of said radio receiver, and a modulator/coder with a radio transmitter for transmitting actuator drive signals disposed downstream of said radio transmitter; and
a central computer connected to said base station.

2. The system according to claim 1,
wherein said communications device also supplies electrical power to said units;
including a magnetic field production apparatus;
including at least one primary winding connected to said magnetic field production apparatus and said primary winding produces a magnetic field, said primary winding disposed in an area of the machine such that the machine is located in an area of influence of said primary winding; and
wherein said communications device has at least one secondary winding suitable for absorbing energy from the magnetic field, and a rectifier disposed downstream of said secondary winding.

3. The system according to claim 2, including at least one resonant capacitor is disposed in one of series and parallel with at least one of said primary winding and said secondary winding to form resonant circuits.

4. A system for a plant having a large number of units selected from the group consisting of sensors and actuators, the system comprising:
connecting cables;
at least one communications device connected to at least two of the units through said connecting cables, said communication device mounted on the plant, said communications device having at least one of a modulator/coder and a radio transmitter for transmitting sensor signals disposed downstream of said modulator/coder, and a radio receiver and a demodulator/decoder for receiving actuator drive signals disposed downstream of said demodulator/decoder;
a base station communicating via radio signals with said communications device, said base station having at least one of a radio receiver and a demodulator/decoder for receiving sensor signals disposed downstream of said radio receiver, and a modulator/coder with a radio transmitter for transmitting actuator drive signals disposed downstream of said radio transmitter; and
a central computer connected to said base station.

5. The system according to claim 4,
wherein said communications device also supplies electrical power to said units;
including a magnetic field production apparatus;
including at least one primary winding connected to said magnetic field production apparatus and said primary winding produces a magnetic field, said primary winding disposed in an area of the plant such that the plant is located in an area of influence of said primary winding; and
wherein said communications device has at least one secondary winding suitable for absorbing energy from the magnetic field, and a rectifier disposed downstream of said secondary winding.

6. The system according to claim 5, including at least one resonant capacitor is disposed in one of series and parallel with at least one of said primary winding and said secondary winding to form resonant circuits.
